(19) United States
(12) Patent Application Publication
(10) Pub. No.: US 2007/0162940 A1
(43) Pub. Date: Jul. 12, 2007

(54) Portable electronic device and a method of playing images on the portable electronic device

(75) Inventors: Sung-Min Pae, Chung Ho City (TW); Hyun Chul Park, Chung Ho City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Power Quotient International Co., Ltd.

(21) Appl. No.: 11/639,286

(22) Filed: Dec. 15, 2006

(30) Foreign Application Priority Data
Dec. 23, 2005 (TW) 094146065

(51) Int. Cl. H04N 7/18; H04N 7/173; H04N 5/44; H04N 7/16

(52) U.S. Cl. 725/80; 725/131; 725/139; 348/725; 725/74

(57) ABSTRACT

A method of playing images on a portable electronic device is disclosed to include the steps of: providing a portable electronic device that comprises a display device, a browser program, a USB port, a USB OTG module, and a memory, and said browser program includes an editing function; connecting a digital camera device to said portable electronic device, and said digital camera device comprises a display device, a USB port, and a memory; thereby said USB OTG module detects whether or not said memory of said digital camera device includes a multimedia file; if yes, then call said browser program and display said multimedia file on said display device; and a user using said editing function to operate said multimedia file on said portable electronic device. The present invention also relates to a portable electronic device, which can control playing images of a digital camera device on the portable electronic device.

### BACKGROUND OF THE INVENTION

1. Field of the Invention

The present invention relates to a method of playing images on the portable electronic device and more particularly, to such a method that allows a user to control a digital camera device to operate the options of view, play, delete, edit, copy and add through a portable electronic device.

2. Description of the Related Art

When using a conventional digital camera device, such as digital still camera or digital video camera to take photos (images) or browse pictures (or a film), the image data is stored in the memory (or memory card), and then the digital camera device is switched to browser or play mode to browse or play the data. However, the built-in display device (for example, LCD) of a digital still camera or digital video camera has a small size. Therefore, a digital still camera or digital video camera may be connected to a LCD TV or an electronic device having a big size display device (for example, LCD) for browsing or playing.

A digital still camera or digital video camera may be connected to an electronic device having a big size display device by means of a USB interface. However, in a USB interface architecture, the host or the main member of the preceding unit is the master end, and all USB bus signals must be sent out through the host. When two USB “slave” devices, for example, the digital still camera or digital video camera and the electronic device having a big size display device are electrically connected together, neither end can be used as the master, thus linking is not possible. In June 1996, USB-IF defined USB OTG to compensate the drawback of USB, thereby solving the problem. USB OTG is the abbreviation of USB On-The-Go. This USB OTG has the advantage similar point-to-point of 1394-FireWare, which allows one USB “slave” to read data from another USB “slave” device without through the host.

By means of USB OTG function, an electronic device having a big size display device can be connected to a digital still camera or digital video camera to use the memory of the digital still camera or digital video camera for storing data. Thus, the image file or multimedia file stored in the memory of the digital still camera or digital video camera can be copied to the storage device of the electronic device for playing. However, the aforesaid USB OTG function is simply to copy an image file or multimedia file from the digital still camera or digital video camera to the electronic device for playing. It cannot operate view, play, delete, edit, copy and add functions on the electronic device. Further, the electronic device starts to decompress and display the image or multimedia file only after copy of the complete image or multimedia file has been done. Thus, this method wastes much copy time.

Taiwan patent publication no. 571520, filed on May 17, 2002, published on Jan. 11, 2004, discloses a palmtop device entitled “Self-Constructed Multipurpose Module Palmtop Device and its Multipurpose Module Constructing Method”. The self-constructed multipurpose module palmtop device comprises a transceiver for wireless communication with a master consumer device, one or more connection points for the connection of one or more module elements, and a processor for constructing the palmtop device and the module elements subject to the communication result received from the master consumer device; wherein it comprises browser application program for wireless communication between the palmtop device and the intelligent device. According to this patent, the palmtop device can communicate with the master consumer device within a predetermined distance from the master consumer device. However, this palmtop device does not have any image fetch device and the function of directly browsing fetched images under the image fetch mode.

Therefore, it is desirable to provide a portable electronic device and a method of playing images on the portable electronic device that allows a user to control a digital camera device to operate the options of view, play, delete, edit, copy and add through a portable electronic device, and to copy a multimedia file partially to the memory of the portable electronic device for enabling the portable electronic device to directly fetch data from the memory for playing, and to continuously copy the multimedia file to the memory till the end of the playing of the multimedia file, thereby saving much copy time.

### SUMMARY OF THE INVENTION

The present invention has been accomplished under the circumstances in view. It is the main object of the present invention to provide a method of playing images on a portable electronic device, which allows a user to control a digital camera device to operate the options of view, play, delete, edit, copy and add through a portable electronic device. It is another object of the present invention to provide a portable electronic device and a method of playing images on the portable electronic device, which can copy a multimedia file partially to the memory of the portable electronic device for enabling the portable electronic device to directly fetch data from the memory for playing, and continuously copy the multimedia file to the memory till the end of the playing of the multimedia file.

To achieve these and other objects of the present invention, a portable electronic device in accordance with the present invention comprises a display device, a browser program, which includes an editing function, a USB port for coupling to a digital camera device, a USB OTG module coupled to the USB port, a microcontroller coupled to the display device, the USB port and the USB OTG module for controlling the operation of the portable electronic device, and a memory coupled to the microcontroller for storing data, wherein when the digital camera device is connected to the portable electronic device, the USB OTG detects whether or not the digital camera device includes a multimedia file, and then calls the browser program and displays the multimedia file on the display means, if yes, for enabling a user to use the editing function to operate the multimedia file on the portable electronic device.

To achieve the aforesaid and other objects of the present invention, the method of playing images on a portable electronic device comprises the steps of: providing a portable electronic device, the portable electronic device, which comprises at least a display device, a browser program, a USB port, a USB OTG module, and a memory, which browser program including an editing function; connecting a digital camera device to the portable electronic device, which digital camera device comprising a display device, a USB port, and a memory; the USB OTG module detecting whether or not the memory of the digital camera device includes a multimedia file, and then calling the browser program and displaying the multimedia file on the display device of the portable electronic device, if yes; and a user using the editing function to operate the multimedia file on the portable electronic device.

### BRIEF DESCRIPTION OF THE DRAWINGS

FIG. 1 is a schematic drawing showing the connection between a portable electronic device and a digital camera device according to the present invention.

FIG. 2 is a flow chart of a method of playing images on the portable electronic device according to the present invention.

### DETAILED DESCRIPTION OF THE PREFERRED EMBODIMENT

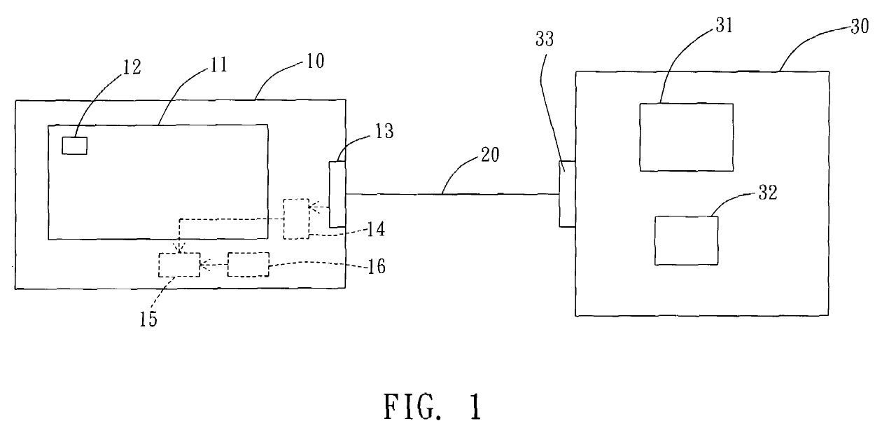

Referring to FIG. 1, a portable electronic device 10 is shown connected to a digital camera device 30. The portable electronic device 10 according to the present preferred embodiment is a portable media player (PMP) for playing any of a variety of multimedia files including image files, picture files, music files and movie files. Further, the portable electronic device 10 is connected to the digital camera device 30 by a USB cable 20. The digital camera device 30 comprises a display device 31 and a memory 32. The portable electronic device 10 comprises a display device 11, a browser program 12, a USB port 13, a USB OTG module 14, a microcontroller 15, and a memory 16.

The display device 11 is a LCD of which the size is greater than the display device 31 of the digital camera device 30.

The browser program 12 is capable of executing an editing function that provides the options of view, play, delete, edit, copy, and add.

The USB port 13 is for coupling to the digital camera device 30.

The USB OTG module 14 is coupled to the USB port 13, having a USB OTG interface. The USB OTG interface has similar point-to-point advantage of 1394-FireWare. This advantage allows one USB “Slave” device to read files from another USB “Slave” device without through the master computer.

The microcontroller 15 is coupled to the display device 11, the USB port 13 and the USB OTG module 14 for controlling the operation of the portable electronic device 10.

The memory 16 is coupled to the microcontroller 15 for storing data.

During operation, the user can use the digital camera device 30 to take pictures or make movies. When the user wishes to see the pictures or the movie, connect the digital camera device 30 to the portable electronic device 10 by the USB cable 20. At this time, the USB OTG module 14 starts to detect whether or not the memory 32 of the digital camera device 30 includes a multimedia file, for example but not limited to, an image file, picture file, music file or movie file. If yes, the call the browser program 12 and display the multimedia file on the display device 11. At this time, the user can see from the display device 11 the picture and image files stored in the memory 32, and use the editing function to operate the multimedia file on the portable electronic device 10. The user can also use the editing function of the browser program 12 to edit the multimedia file, or use the delete function to delete the multimedia file.

When playing the multimedia file, the portable electronic device 10 further provides a buffering function for enabling a part of the multimedia file to be copied to the memory 16 of the portable electronic device 10 in advance. For example, if the size of the multimedia file stored in the memory 32 is 1 GB and the capacity of the memory 16 of the portable electronic device 11 is 32 KB, the microcontroller 15 copies 32 KB data to the memory 16. The microcontroller 15 can directly fetch data from the memory 16 for playing and continuously copy the multimedia file to the memory 16 till the end of the playing of the multimedia file. This buffering function is similar to pipeline processing function, thereby saving much file copy time. Therefore, the portable electronic device 10 of the present invention effectively improves the drawbacks of the prior art designs.

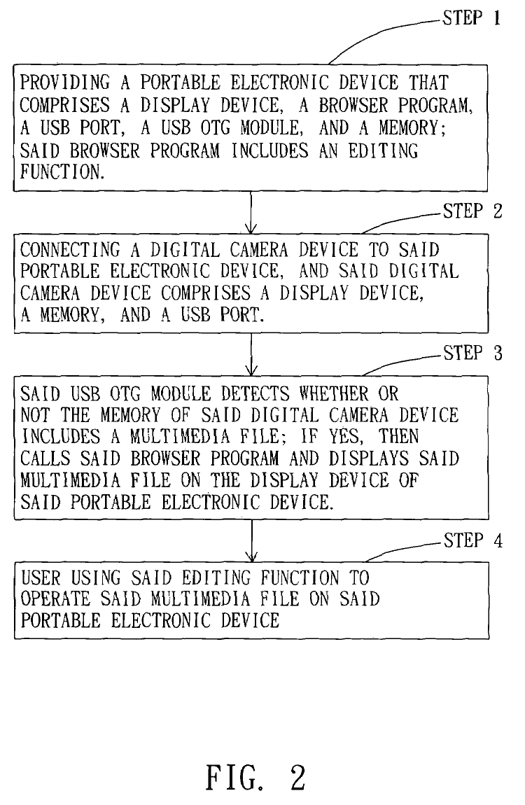

FIG. 2 is a flow chart of a method of playing images on the portable electronic device according to the present invention. As illustrated, the method of playing images on the portable electronic device according to the present invention comprises the steps of: providing a portable electronic device 10 that comprises a display device 11, a browser program 12, a USB port 13, a USB OTG module 14, and a memory 16, and said browser program 12 includes an editing function (Step 1); connecting a digital camera device 30 to said portable electronic device 10, and said digital camera device 30 comprises a display device 31, a memory 32, and a USB port 33 (Step 2); thereby said USB OTG module 14 detects whether or not the memory 32 of said digital camera device 30 includes a multimedia file; if yes, then said USB OTG module 14 calls said browser program 12 and displays said multimedia file on the display device 11 of said portable electronic device 10 (Step 3); and a user using said editing function to operate said multimedia file on said portable electronic device 10 (Step 4).

In the aforesaid Step 1, the display device 11 of said portable electronic device 10 is preferably a LCD of which the size is greater than the display device 31 of the digital camera device 30; said browser program 12 is capable of executing on said portable electronic device 10 an editing function that provides options of view, play, delete, edit, copy and add; said USB port 13 is for coupling to said digital camera device 30; said USB OTG module 14 is coupled to said USB port 13, having a USB OTG interface, said USB OTG interface having similar point-to-point advantage of 1394-FireWare that allows one USB “Slave” device to read files from another USB “Slave” device without through the master computer.

In the aforesaid Step 2, said digital camera device 30 is connected to said portable electronic device 10 by a USB cable 20, wherein said digital camera device 30 comprises at least a display device 31, a memory 32, and a USB port 33; wherein said display device 31 is a LCD of which the size is smaller than the display device 11 of said portable electronic device 10, said memory 32 is for storing said multimedia file and has a size greater than the memory 16 of said portable electronic device 10, for example, the capacity of the memory 32 is 1 GB and the capacity of the memory 16 is 32 KB.

In the aforesaid Steps 3˜4, when said digital camera device 30 is connected to said portable electronic device 10 by said USB cable 20, said USB OTG module 14 starts to detect whether or not the memory 32 of said digital camera device 30 includes a multimedia file, for example but not limited to, an image file, picture file or music file; if yes, then call said browser program 12 and display said multimedia file on the display device 11 of said portable electronic device 10. At this time, the user can see from the display device 11 the picture and image files stored in the memory 32 and use the play option of the editing function to play said multimedia file on the display device 11 of said portable electronic device 10. The user can also use the editing function of the browser program 12 to edit said multimedia file on the display device 11 of said portable electronic device 10, or the delete function of the browser program 12 to delete the multimedia file.

Further, during the step of playing said multimedia file, the method of the present invention provides a buffering step, which allows a part of said multimedia file to be copied to the memory 16 of said portable electronic device 10, for example, if the size of said multimedia file stored in the memory 32 said digital camera device 30 is 1 GB and the capacity of the memory 16 of said portable electronic device 11 is 32 KB, the microcontroller 15 copies 32 KB data to the memory 16. The microcontroller 15 can directly fetch data from the memory 16 for playing and continuously copy said multimedia file to the memory 16 till the end of the playing of the multimedia file. This buffering function is similar to pipeline processing function, thereby saving much file copy time. Therefore, the portable electronic device 10 of the present invention effectively improves the drawbacks of the prior art designs.

By means of the application of the present invention, a portable electronic device can be used to control a digital camera device to operate the options of view, play, delete, edit, copy and add, and to copy a multimedia file partially to the memory of the portable electronic device, for enabling the portable electronic device to directly fetch data from the memory for playing and to continuously copy the multimedia file to the memory till the end of the playing of the multimedia file, thereby saving much copy time. Therefore, the invention effectively improves the drawbacks of the prior art designs.

A prototype of portable electronic device and method of playing images on the portable electronic device has been constructed with the features of FIGS. 1 and 2. The portable electronic device and method of playing images on the portable electronic device functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A method of playing images on a portable electronic device comprising the steps of:
providing a portable electronic device, said portable electronic device comprising at least a display device, a browser program, a USB port, a USB OTG module, and a memory, said browser program providing an editing function;
connecting a digital camera device to said portable electronic device, said digital camera device comprising a display device, a USB port, and a memory;
said USB OTG module detecting whether or not the memory of said digital camera device includes a multimedia file, and then calling said browser program and displaying the multimedia file on the display device of said portable electronic device, if yes; and
a user using said editing function to operate said multimedia file on said portable electronic device.

2. The method as claimed in claim 1, wherein said portable electronic device is a portable media player.

3. The method as claimed in claim 1, wherein said digital camera device is a digital still camera or a digital video camera.

4. The method as claimed in claim 1, wherein said editing function provides the options of view, play, delete, edit, copy, and add.

5. The method as claimed in claim 4, wherein the option of play further comprises a buffering procedure, which copies a part of said multimedia file to the memory of said portable electronic device for enabling said portable electronic device to directly fetch data from the memory thereof for playing and to continuously copy said multimedia file to the memory thereof till the end of the playing of said multimedia file.

6. The method as claimed in claim 1, wherein said multimedia file is an image file, a picture file or a music file.

7. A portable electronic device comprising at least:
display means;
a browser program, said browser program providing an editing function;
a USB port for coupling to a digital camera device;
a USB OTG module coupled to said USB port;
a microcontroller coupled to said display means, said USB port and said USB OTG module for controlling operation of the portable electronic device; and
memory means coupled to said microcontroller for storing data;
wherein when a digital camera device is coupled to said USB port, said USB OTG detects whether or not said digital camera device includes a multimedia file, and then calls said browser program and displays the multimedia file on said display means, if yes, for enabling a user to use said editing function to operate the multimedia file on the portable electronic device.

8. The portable multimedia device as claimed in claim 7, which is a portable media player.

9. The portable multimedia device as claimed in claim 7, wherein said digital camera device is a digital still camera or a digital video camera.

10. The portable multimedia device as claimed in claim 7, wherein said editing function provides the options of view, play, delete, edit, copy, and add.

11. The portable multimedia device as claimed in claim 10, wherein when the option of play is selected, said microcontroller copies a part of the multimedia file to said memory means, and then fetches data from said memory means for playing and continuously copies the multimedia file to said memory means till the end of the playing of said multimedia file.

12. The portable multimedia device as claimed in claim 10, wherein said multimedia file is an image file, a picture file or a music file.
